(19) United States
(12) Patent Application Publication
(10) Pub. No.: US 2006/0095940 A1
(43) Pub. Date: May 4, 2006

(54) Method and apparatus for distributing digital stream data to a user terminal

(76) Inventor: Bradley N. Yearwood, Cotati, CA (US)

Correspondence Address: Kin-Wah Tong;Moser, Patterson & Sheridan, LLP, Suite 100, 595 Shrewsbury Avenue, Shrewsbury, NJ, 07702, US

(21) Appl. No.: 10/980,725

(22) Filed: Nov. 3, 2004

(51) Int. Cl. H04N 7/18

(52) U.S. Cl. 725/80; 725/74; 725/78

(57) ABSTRACT

Method and apparatus for distributing digital stream data over a local distribution facility to at least one user terminal is described. In one example, a transceiver is configured to receive a signal from a transport system and recover a packet stream from the signal. Packet processing circuitry is configured to extract digital stream data from the packet stream. A modulator is configured to modulate the digital stream data onto at least one carrier for transmission over the local distribution facility to at least one user terminal.

### BACKGROUND OF THE INVENTION

1. Field of the Invention

The present invention generally relates to content distribution systems and, more particularly, to a method and apparatus for distributing digital stream data to a user terminal.

2. Description of the Related Art

Multimedia distribution systems are becoming increasingly important vehicles for delivering video, audio and other data (generally referred to as content services) to and from remote users. Notably, switched digital video (SDV) systems have been developed to deliver content services to subscribers over limited bandwidth transmission networks. Such transmission networks include, for example, digital subscriber line (DSL) networks and fiber-to-the-curb (FTTC) networks. Typically, the number of channels for content service transmission that are supported by the transmission network is less than the total number of content services accessible by the SDV system. Thus, the SDV system is configured to switch subscriber-desired content services among the available channels supported by the transmission network.

SDV systems typically distribute content services using a packet-based transmission protocol, such as asynchronous transfer mode (ATM), transmission control protocol/internet protocol (TCP/IP), and the like, as well as combinations of such protocols (e.g., TCP/IP encapsulated by ATM). Subscribers receive the packetized services via the appropriate termination equipment (e.g., DSL modems). Historically, in order to display the audiovisual data, the subscribers must employ a local distribution facility capable of propagating the packetized video services between the termination equipment and the display devices (e.g., televisions). For example, subscribers may be required to employ category-5 (CAT5) Ethernet cable between the display devices and the termination equipment. Moreover, the subscribers typically require specialized packet-processing receivers for processing the packetized services at the display devices. Employing such distribution facilities and specialized packet-processing receivers may engender additional expense and are thus undesirable.

Accordingly, there exists a need in the art for a method and apparatus that distributes audiovisual data to a user terminal in a SDV system.

### SUMMARY OF THE INVENTION

A method and apparatus for distributing digital stream data to a user terminal is described. One aspect of the invention relates to an apparatus for distributing digital stream data over a local distribution facility to at least one user terminal. In one embodiment, a transceiver is configured to receive a signal from a transport system and recover a packet stream from the signal. Packet processing circuitry is configured to extract digital stream data from the packet stream. A modulator is configured to modulate the digital stream data onto at least one carrier for transmission over the local distribution facility to at least one user terminal.

Another aspect of the invention relates to a content distribution system. A headend is configured to provide packetized data carrying digital stream data. A transport system is configured to propagate a signal adapted to carry the packetized data. A network interface is coupled to the transport system. The network interface includes a transceiver, packet processing circuitry, and a modulator. The transceiver is configured to receive a signal from the transport system and recover the packetized data from the signal. The packet processing circuitry is configured to extract the digital stream data from the packetized data. The modulator is configured to modulate the digital stream data onto at least one carrier. A local distribution facility is configured to receive each carrier from the network interface. At least one user terminal is coupled to the local distribution facility. Each user terminal is configured to process each carrier to display the digital stream data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a content distribution system in which the present invention may be utilized;

FIG. 2 is a block diagram depicting an exemplary embodiment of a subscriber system of FIG. 1 constructed in accordance with the invention;

FIG. 3 is a more detailed block diagram depicting an exemplary embodiment of a network interface of FIG. 2 constructed in accordance with the invention;

FIG. 4 is a more detailed block diagram depicting another exemplary embodiment of a network interface of FIG. 2 constructed in accordance with the invention; and

FIG. 5 is a more detailed block diagram depicting yet another exemplary embodiment of a network interface of FIG. 2 constructed in accordance with the invention.

To facilitate understanding, identical reference numerals have been used, wherever possible, to designate identical elements that are common to the figures.

### DETAILED DESCRIPTION OF THE INVENTION

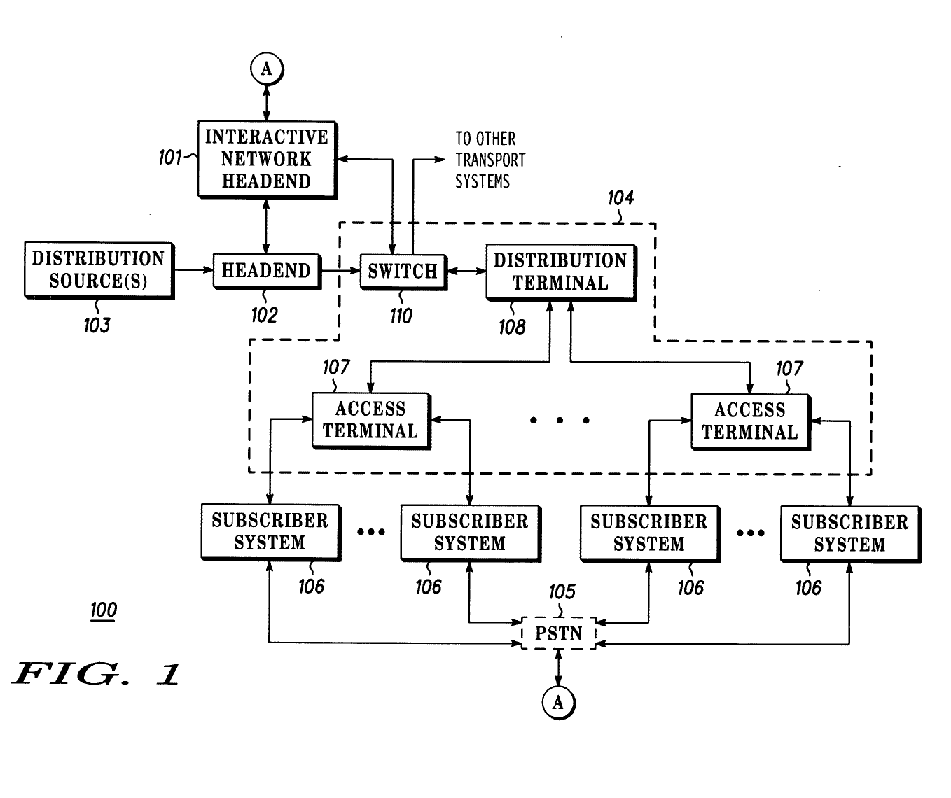

FIG. 1 is a block diagram depicting an exemplary embodiment of a content distribution system 100 in which the present invention may be utilized. The system 100 comprises a headend 102, a transport system 104, and a plurality of subscriber systems 106. The transport system 104 illustratively comprises a switch 110, a distribution terminal 108, and a plurality of access terminals 107. The headend 102 delivers content services obtained from one or more distribution sources 103 to the subscriber systems 106 via the transport system 104. The distribution sources 103 may include satellite distribution networks, local broadcast networks, video-on-demand (VOD) networks, and like type content sources known in the art.

In particular, the headend 102 receives various digital streams from the distribution sources 103. Each of the digital streams includes one or more of a video component, an audio component (including one or more audio streams), and an ancillary data component. The digital streams may be formatted in accordance with various transport and coding techniques that comply with well known standards developed by the Motion Picture Experts Group (MPEG) and International Telecommunications Union (ITU-T), such as MPEG-1, MPEG-2, MPEG-4, ITU-T H261, and ITU-T H263 standards. For purposes of clarity by example, the digital streams are described as being MPEG-2 single program transport streams (SPTSs), although other types of transport streams and coding techniques may be used.

The digital streams are encapsulated using one or more packet-based transmission protocols and transmitted from the headend 102 to the transport system 104. The term “packet-based transmission protocol,” as used herein, is meant to encompass any protocol known in the art that is configured to transmit information using packets, cells, frames, or like type data units. For purposes of clarity by example, the digital streams are described as being transmitted to the switch 110 using an asynchronous transport mode (ATM) protocol (e.g., ATM adaptation layer 5 (AAL5)). Each of the digital streams occupies an ATM virtual circuit (VC) in a virtual path (VP) between the headend 102 and the transport system 104. The digital streams may be distinguished using VCNP identifiers. Optionally, each of the digital streams may be first encapsulated using a network/transport protocol (e.g., User Datagram Protocol/Internet Protocol (UDP/IP)) and then encapsulated using an ATM protocol. In yet another alternative, the digital streams may be encapsulated using only a network/transport protocol, such as UDP/IP. In such a configuration, the streams may be distinguished by one or more of source IP address, destination IP address, and UDP port number, for example.

Some or all of digital streams are dropped at the switch 110 and provided to the distribution terminal 108. The switch 110 may pass on the digital streams to other transport systems (not shown). The distribution terminal 108 is coupled to each of the access terminals 107. The distribution terminal 108 delivers the digital streams to the access terminals 107 for distribution to the subscriber systems 106. Each of the access terminals 107 provides a distribution node for a set of the subscriber systems 106.

The digital streams may be distributed to the subscriber systems 106 through the access terminals 107 using optical fiber, copper wire, coaxial cable, or like-type transmission media known in the art, as well as combinations of such facilities. For example, the digital streams may be distributed using a digital subscriber line (DSL) facility, where data is delivered to one or more of the subscriber systems 106 entirely over copper wire. The term “DSL” is meant to encompass very high-speed DSL (VDSL), asynchronous DSL (ADSL), and the like (generally referred to as XDSL). Alternatively, the digital streams may be distributed using a fiber-to-the-curb (FTTC) or fiber-to-the-node (FTTN) facility, where data is delivered over optical fiber to one or more of the access terminals 107, and over copper wire or coaxial cable from the access terminals 107 to the respective subscriber systems 106. In yet another example, the digital streams may be distributed using a fiber-to-the-home (FTTH) or fiber-to-the-building (FTTB) facility, where data is delivered to one or more of the subscriber systems 106 entirely over optical fiber. In yet another example, the digital streams may be distributed entirely over coaxial cable or a combination of coaxial cable and optical fiber using a DOCSIS (Data Over Cable Service Interface Specification) transmission facility. DSL, FTTC, FTTN, FTTH, FTTB, and DOCSIS transmission facilities are well-known in the art. As such, the details of such transmission facilities are not described in detail herein.

Typically, the distribution terminal 108, or both the distribution terminal 108 and the access terminals 107, receive more digital streams than can be distributed to a subscriber system 106 at any given time. For example, out of a hundred digital streams, there may be sufficient bandwidth to transmit only three digital streams from an access terminal 107 to each of the respective subscriber terminals 106. The system 100 allows the subscriber systems 106 to access all of the available digital streams provided by the distribution sources 103 by switching the available digital streams into the available bandwidth between the access terminals 107 and the subscriber systems 106 in response to command data produced by the subscriber systems 106 (e.g., channel change requests).

Notably, the command data generated by the subscriber systems 106 may be sent to one or more of the access terminals 107, the distribution terminal 108, and an interactive network headend 101, through the transport system 104 via a bidirectional channel. For example, the distribution terminal 108 may receive channel change requests from the subscriber systems 106. In response to channel change requests, the distribution terminal 108 may multicast digital streams to the access terminals 107 of the requesting subscriber systems 106 on the basis of ATM VPNC distinction of the digital streams. The same channel-change technique may also be employed by the access terminals 107. In another example, a channel change request may be communicated to the interactive network headend 101, which may instruct the headend to provide particular digital streams (e.g., VOD streams). The particular digital streams may then be routed through the distribution terminal and an access terminal 107 to the requesting subscriber system 106. In another alternative, command data may be sent to the interactive network headend 101 through another communication link, such as a publicly switched telephone network (PSTN) 105.

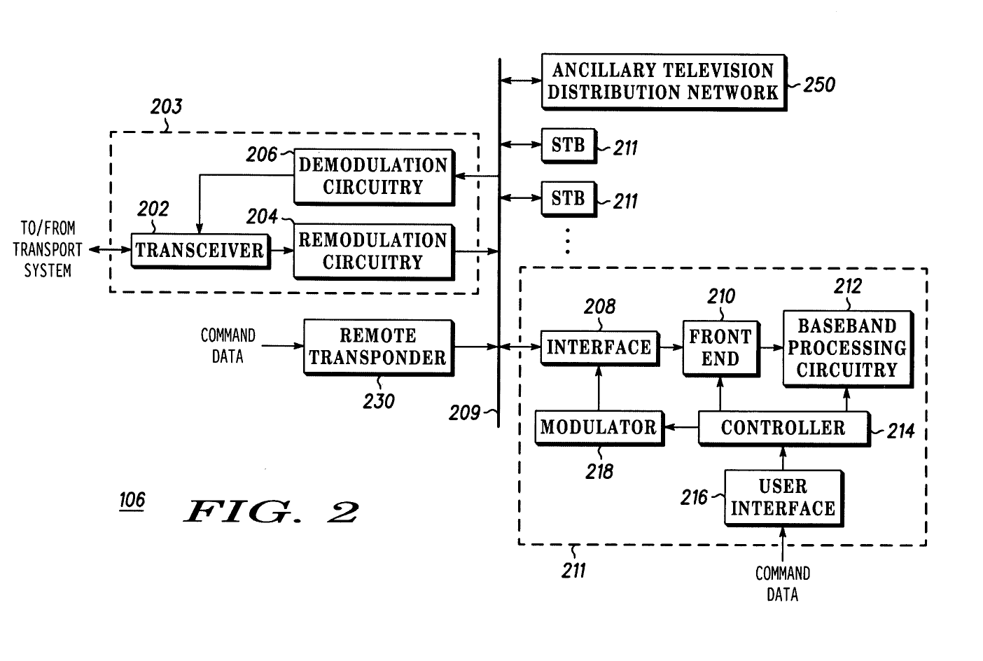

FIG. 2 is a block diagram depicting an exemplary embodiment of a subscriber system 106 of FIG. 1 constructed in accordance with the invention. The subscriber system 106 comprises a network interface 203, a local distribution facility 209, and one or more user terminals (e.g., set-top boxes (STBS) 211). Although the invention is described with respect to STBs 211, those skilled in the art will appreciate that other types of user terminals may be employed, such as integrated digital television receivers. The local distribution facility 209 comprises a conventional facility for delivering television signals, such as coaxial cable. The network interface 203 processes data from an access terminal 107 to extract digital streams. The network interface 203 couples signals into the local distribution facility to carry the digital streams to the STBs 211.

The STBs 211 are configured to process the digital streams for display of the audio/video/data contained therein to subscribers. The STBs 211 are also configured to generate command data (e.g., channel-change requests) for selecting specific digital streams. The command data may be sent upstream via the network interface 203, or through another communication link, such as a PSTN.

The local distribution facility 209 may also be coupled to an ancillary television distribution network 250. For example, the ancillary television distribution network 250 may comprise a cable television transport facility, such as a hybrid fiber-coax (HFC) facility. Television signals (either analog signals or digital signals) may be coupled to the local distribution facility 209 from the ancillary television distribution network 250 in a conventional manner. The television signals from the ancillary television distribution network 250 may be superimposed over the signals carrying the digital streams provided by the network interface 203.

In the present embodiment, the network interface 203 includes a transceiver 202, re-modulation circuitry 204, and demodulation circuitry 206. An interface of the transceiver 202 is coupled to the transport system 104. An input interface of the re-modulation circuitry 204 is coupled to another interface of the transceiver 202. An output interface of the re-modulation circuitry 204 is coupled to the local distribution facility 209. An input interface of the demodulation circuitry 206 is coupled to the local distribution facility 209. An output interface of the demodulation circuitry 206 is coupled to another interface of the transceiver 202.

In operation, the transceiver 202 receives signals carrying the digital streams from an access terminal 107. In one embodiment, the signals may be optical signals received from an optical fiber link of the transport system 104 (e.g., a FTTH implementation). Alternatively, the signals may be radio frequency (RF) signals received from a copper wire link of the transport system 104 (e.g., a DSL or FTTC implementation). In either case, the transceiver 202 processes the received signals to extract the digital streams therefrom. Notably, the transceiver 202 depacketizes the digital streams from at least one level of packetization. For example, the transceiver 202 may extract the digital streams from a TCP/IP data stream, which has been extracted from an ATM cell stream.

The re-modulation circuitry 204 receives the digital streams from the transceiver 202. In one embodiment of the invention, the re-modulation circuitry 204 modulates the digital streams onto a carrier and up-converts the carrier to an appropriate transmission frequency. In another embodiment, the re-modulation circuitry 204 modulates each of the digital streams onto a carrier and up-converts each carrier to a separate transmission frequency.

In either embodiment, the modulation scheme employed by the re-modulation circuitry 204 may be quadrature amplitude modulation (QAM) (e.g., ITU J.83A/B/C), vestigial sideband modulation (VSB) (e.g., 8-VSB), quadrature phase-shift keying (QPSK) (e.g., digital video broadcast type S (DVB-S)), coded orthogonal frequency division multiplexing (COFDM) (e.g., DVB-T), or like-type modulation known in the art. The carrier(s) may be upconverted to an RF frequency that complies with the conventional television spectrum (e.g., very high frequency (VHF), ultra-high frequency (UHF), or cable television frequencies). The types of modulation and RF transmission frequency may be selected in accordance with the particular demodulation circuitry contained within the STBs 211. The re-modulation circuitry 204 couples the up-converted carrier(s) to the local distribution facility 209.

Each of the STBs 211 includes an interface 208, a front end 210, baseband processing circuitry 212, a controller 214, a user interface 216, and a modulator 218. The interface 208 is coupled between the local distribution facility 209 and the front end 210. An input interface of the baseband processing circuitry 212 is coupled to an output interface of the front end 210. An output interface of the baseband processing circuitry 212 may be coupled to a television for display of audio/video/data. The user interface 216 is configured to receive command data from a user (e.g., an infrared interface for a remote controller). The user interface 216 is coupled to the controller 214. Interfaces of the front end 210, the baseband processing circuitry 212, and the modulator 218 are respectively coupled to the controller 214. An output interface of the modulator 218 is coupled to the interface 208. For purposes of clarity by example, only a single STB 211 is shown in detail. It is to be understood that each of the STBs 211 may include an interface, a front end, baseband processing circuitry, a controller, a user interface, and a modulator.

In operation, the interface 208 receives one or more up-converted carrier signals from the local distribution facility 209. For example, the interface 208 may be a coaxial cable interface. The front end 210 tunes a particular up-converted carrier to baseband and demodulates the baseband signal to extract digital stream data. The front end 210 may include a QAM demodulator, VSB demodulator, QPSK demodulator, COFDM demodulator, or like-type demodulator known in the art. The baseband processing circuitry 212 processes the digital stream data from the front end 210 for display of audio/video/data to a user. For example, the baseband processing circuitry 212 may comprise an MPEG decoder. The front end 210 and the baseband processing circuitry 212 operate under control of the controller 214. Operational details of the front end 210 and the baseband processing circuitry 212 are well-known in the art and, as such, are not described in detail herein.

In another embodiment, one or more of the STBs 211 may comprise an integrated digital television receiver, wherein the elements 208 through 218 are disposed within a television. In such an embodiment, a remote transponder 230 may be provided to receive command data from the user. The remote transponder 230 is configured to receive channel change commands from the user (e.g., via an infrared remote control) and forward the channel change commands to the demodulation circuitry 206 via the local distribution facility 209. The remote transponder 230 may include a channel number display, since the channel number indicated by the television receiver may not change or may be otherwise misleading in an SDV environment.

The user interface 216 is configured to couple command data from a user to the controller 214. The controller 214 couples the command data to the modulator 218. The modulator 218 modulates the command data onto a carrier for transmission over the local distribution facility 209 to the network interface 203. In the network interface 203, the demodulation circuitry 206 is configured to demodulate carrier signals having command data generated by the STBs 211. The demodulation circuitry 206 couples the command data to the transceiver 202 for transmission to the system 100. While the present embodiment has been described with respect to transmission of command data to the system 100 over the transport system 104, those skilled in the art will appreciate that the STBs 211 may instead transmit the command data to the system 100 over another communication facility, such as the PTSN 105, as described above. In such an embodiment, the demodulation circuitry 206 is not required in the network interface 203.

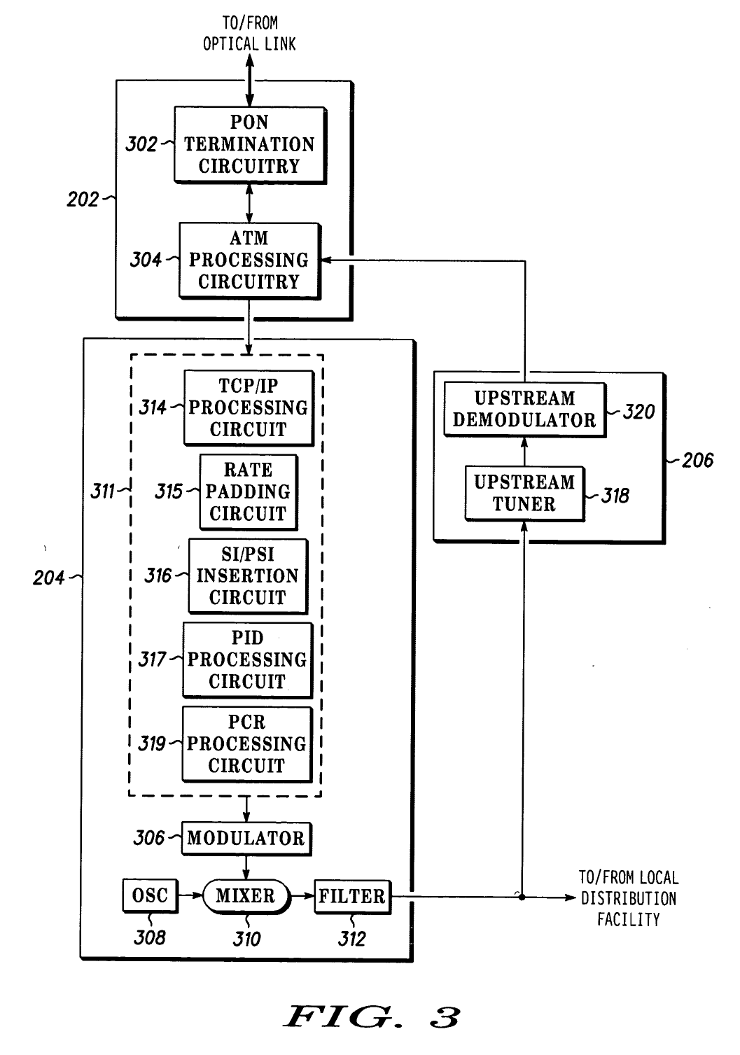

FIG. 3 is a more detailed block diagram depicting an embodiment of the network interface 203 of FIG. 2 constructed in accordance with the invention. Elements of FIG. 3 that are the same or similar to those of FIG. 2 are designated with identical reference numerals and are described above. In the present embodiment, the network interface 203 is coupled to an optical link (e.g., an FTTH embodiment). The transceiver 202 comprises passive optical network (PON) termination circuitry 302 and optionally includes ATM processing circuitry 304. An interface of the PON termination circuitry 302 is coupled to receive data from the transport system 104. The PON termination circuitry 302 processes optical signals received from the transport system 104 to extract packetized data. In one embodiment, another interface of the PON termination circuitry 302 is coupled to the ATM processing circuitry 304.

The ATM processing circuitry 304 processes ATM cells to decapsulate the packetized digital stream data. The ATM processing circuitry 304 may provide the digital stream data as output. Alternatively, the output of the ATM processing circuitry 304 may still be packetized if multiple levels of encapsulation are employed by the system 100. For example, the ATM processing circuitry 304 may output a TCP/IP stream carrying the digital stream data. Operational details of the PON termination circuitry 302 and the ATM processing circuitry 304 are well-known in the art and, as such, are not described in detail herein. While the present embodiment is specifically described with respect to ATM processing circuitry 304, those skilled in the art will appreciate that other types of packet processing circuitry may be employed adapted for use with the various protocols described herein. Notably, the packet processing circuitry employed in the network interface 203 (e.g., the ATM processing circuitry 304) may include one or more packet processors for depacketizing a respective at least one type of packets received from the system 100 (e.g., ATM processors, TCP/IP processors, Ethernet processors, and the like).

The remodulation circuitry 204 comprises a modulator 306, an oscillator 308, a mixer 310, and a filter 312. An input interface of the modulator 306 is coupled to receive digital stream data. An output interface of the modulator 306 is coupled to an input interface of the mixer 310. Another input interface of the mixer 310 is coupled to an output interface of the oscillator 308. An output interface of the mixer 310 is coupled to an input interface of the filter 312. An output interface of the filer 312 is coupled to the local distribution facility 209.

In operation, the modulator 306 modulates the digital stream data onto one or more carrier signals using a desired modulation scheme (e.g., QAM, QPSK, COFDM, VSB, etc). In one embodiment, the modulator 306 receives the digital stream data directly from the ATM processing circuitry 304. Alternatively, the remodulation circuitry 204 may include various circuits 311 for processing the output of the ATM processing circuitry 304 before modulation by the modulator 306. For example, the remodulation circuitry 204 may include a TCP/IP processing circuit 314 for decapsulating the digital stream data from a TCP/IP stream provided by the ATM processing circuitry 304. Alternatively, the TCP/IP processing circuit 314 may receive TCP/IP data directly from the PON termination circuitry 302 if the ATM protocol is not employed. While the TCP/IP processing circuit 314 is specifically described for purposes of clarity by example, those skilled in the art will appreciate that other types of packet processors may be employed, as described above.

The remodulation circuitry 204 may also include a program identifier (PID) processing circuit 317 for PID formation and translation. For example, each of the received digital streams may have their PIDs translated before transmission to the STBs 211. The remodulation circuitry 204 may also include a rate padding circuit 315 for adjusting the data rate of the digital stream data. For example, null packets may be added to pad the digital stream data in accordance with the requirement of the transmission scheme used (e.g., 64 QAM). The remodulation circuitry 204 may also include program clock reference (PCR) processing circuitry 319 for adjusting timestamps in the digital stream data. The PCR processing circuitry 319 may perform well known dejittering techniques to smooth out the effects of transport jitter introduced by the transport system 104.

The remodulation circuitry 204 may further include a system information/program specific information (SI/PSI) insertion circuit 316 for synthesizing and inserting SI/PSI into the digital stream data. For example, SI/PSI may include one or more of a program associate table (PAT), a conditional access table (CAT), a virtual channel table (VCT), an entitlement management message (EMM), an entitlement control message (ECM), and like type system information or program specific information known in the art. Notably, the STBs 211 may be configured to process digital stream data having a particular SI/PSI configuration. For example, the STBs 211 may expect the SI/PSI for the digital stream data to be in an out-of-band control channel. The digital stream data received at the network interface 203 may include program descriptive data having a different configuration than the SI/PSI that is expected by the STBs 211. In such a case, the SI/PSI insertion circuit 316 may synthesize the SI/PSI configuration expected by the STBs 211 from the program descriptive data provided by the system 100 (e.g., the SI/PSI insertion circuit 316 may synthesize and out-of-band channel having SI/PSI).

The carrier(s) generated by the modulator 306 are coupled to the mixer 310 and up-converted to an RF frequency in accordance with the oscillator 308. The RF carrier(s) generated by the mixer 310 are filtered by the filter 312 (e.g., a low-pass filter) to reject unwanted sidebands generated by the mixer 310. The filtered RF carrier(s) are then coupled to the local distribution facility 209 for distribution to the STBs 211. Operation of the mixer 310, oscillator 308, and the filter 312 to up-convert carriers to RF frequencies is well known in the art. In another embodiment, direct digital synthesis/upconversion may be employed by the modulator 306, obviating the need for the oscillator 308, the mixer 310, and the filter 312.

The demodulation circuitry 206 comprises an upstream tuner 318 and an upstream demodulator 320. An input interface of the upstream tuner 318 is coupled to the local distribution facility 209. An output interface of the tuner 318 is coupled to an input interface of the upstream demodulator 320. An output interface of the upstream demodulator 320 is coupled to an input interface of the ATM processing circuitry 304. In operation, the upstream tuner 318 receives an RF carrier carrying command data generated by the STBs 211. The upstream tuner 318 tunes the RF carrier (e.g., downconverts the RF carrier) in a well-known manner to generated baseband data. The upstream demodulator 320 demodulates the baseband data to extract the command data therefrom in a well-known manner. The command data is coupled to the ATM processing circuitry 304 for encapsulation into ATM cells and transmission to the transport system 104 via the PON termination circuitry 302.

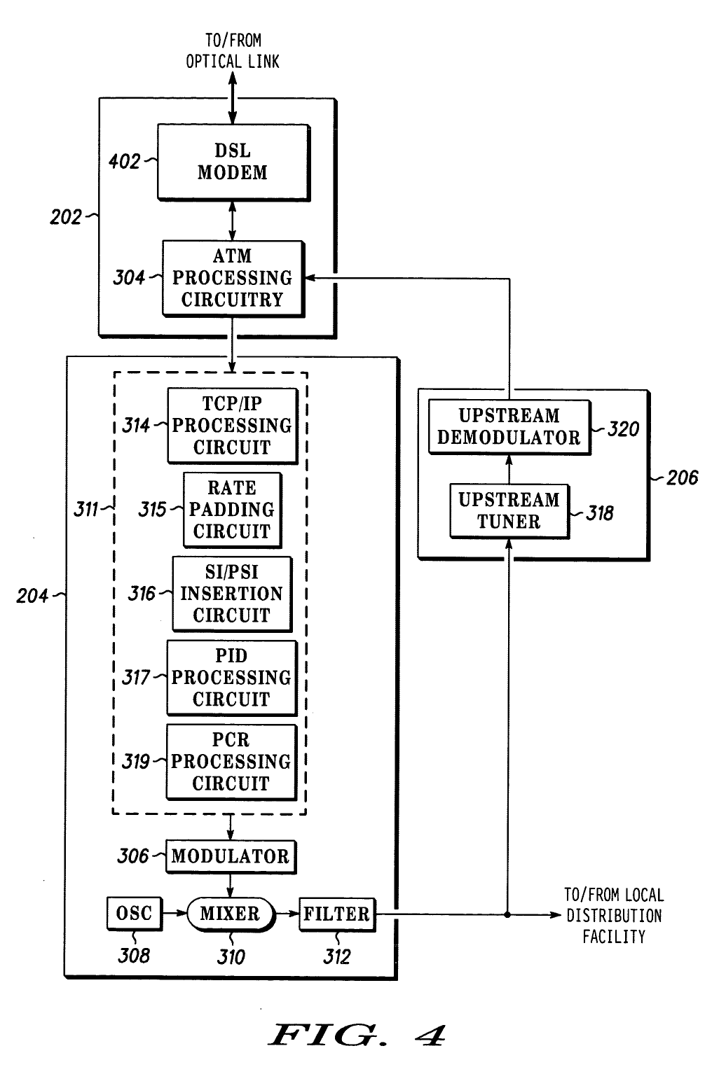

FIG. 4 is a more detailed block diagram depicting another exemplary embodiment of the network interface 203 of FIG. 2. Elements of FIG. 4 that are the same or similar to those of FIGS. 2-3 are designated with identical reference numerals and are described above. In the present embodiment, the network interface 203 is coupled to a copper pair of the transport system 104 (e.g., a FTTC embodiment or a DSL embodiment). In place of the PON termination circuitry 302, the transceiver 202 comprises a DSL modem 402. An interface of the DSL modem 402 is coupled to the local distribution facility 209. An output interface of the DSL modem 402 is coupled to the ATM processing circuitry 304. The DSL modem 402 is capable of modulating and demodulating data in accordance with a particular DSL standard (e.g., VDSL, ADSL, etc.). Notably, the DSL modem 402 is configured to process the DSL signals received from the transport system 104 to extract the packetized data carrying the digital streams therefrom. The packetized data is coupled to the ATM processing circuitry 304 and processed as described above with respect to FIG. 3. Operation of the DSL modem 402 is well-known in the art.

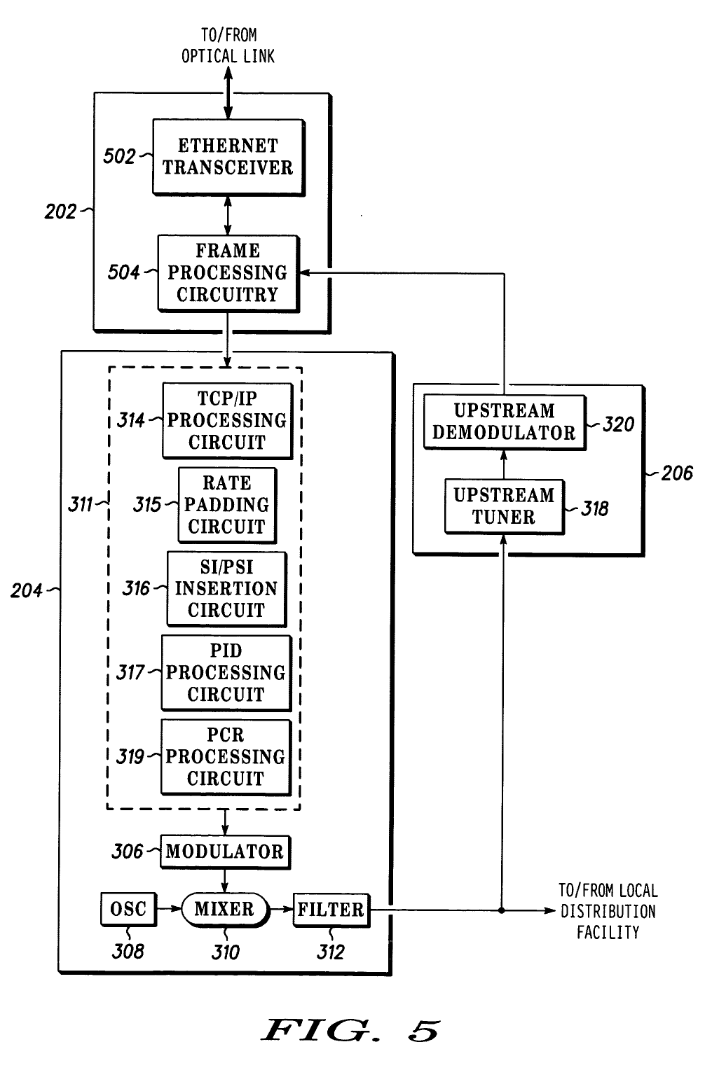

FIG. 5 is a more detailed block diagram depicting another exemplary embodiment of the network interface 203 of FIG. 2. Elements of FIG. 5 that are the same or similar to those of FIGS. 2-4 are designated with identical reference numerals and are described above. In the present embodiment, the network interface 203 is configured to receive Ethernet frames from the transport system 104. The transceiver 202 comprises an Ethernet transceiver 502 and frame processing circuitry 504. An interface of the Ethernet transceiver 502 is coupled to the local distribution facility 209. An output interface of the Ethernet transceiver 502 is coupled to the frame processing circuitry 504. The Ethernet transceiver is capable of transmitting and receiving data in accordance with the well known Ethernet standard. The frame processing circuitry 504 is configured to process the Ethernet frames received by the Ethernet transceiver 502 to extract the packetized data carrying the digital streams therefrom. Operation of the Ethernet transceiver 502 and the frame processing circuitry 504 is well-known in the art.

Method and apparatus for distributing digital streams to a user terminal is described. A network interface is configured to process digital stream data from a SDV network for distribution to one or more user terminals. The user terminals may be set-top boxes, integrated television receivers, and the like, which are configured for off-air reception of television signals (either analog or digital). The network interface is configured to remodulate the digital stream data received from an SDV system for distribution to the user terminals via a local distribution facility coupled to the off-air interfaces of the user terminals. For example, the local distribution facility may be a coaxial cable medium coupled to a coaxial cable interface of each user terminal. In this manner, subscribers may view SDV content using existing user terminal devices and coaxial cable facilities, without employing an additional transmission facility, such as a category five transmission facility for propagating Ethernet.

While the foregoing is directed to illustrative embodiments of the present invention, other and further embodiments of the invention may be devised without departing from the basic scope thereof, and the scope thereof is determined by the claims that follow.

1. Apparatus for distributing digital stream data over a local distribution facility to at least one user terminal coupled thereto, the apparatus comprising:
a transceiver for receiving a signal from a transport system and recovering a packet stream from said signal;
packet processing circuitry for extracting digital stream data from said packet stream; and
a modulator for modulating said digital stream data onto at least one carrier for transmission over said local distribution facility to said at least one user terminal.

2. The apparatus of claim 1, further comprising:
up-conversion circuitry for up-converting a frequency of each said at least one carrier for transmission over said local distribution facility.

3. The apparatus of claim 2, wherein said frequency of said at least one carrier is up-converted to one of a very high frequency (VHF), an ultra high frequency (UHF), and cable television frequency.

4. The apparatus of claim 1, wherein said signal comprises an optical signal, and wherein said transceiver comprises:
optical network termination circuitry for receiving said optical signal.

5. The apparatus of claim 1, wherein said signal comprises a radio frequency signal, and where said transceiver comprises:
a modem for receiving said radio frequency signal.

6. The apparatus of claim 5, wherein said radio frequency signal is a digital subscriber line (DSL) signal.

7. The apparatus of claim 1, wherein said packet processing circuitry comprises:
at least one packet processor for depacketizing said packet stream.

8. The apparatus of claim 7, wherein said at least one packet processor comprises at least one of:
an asynchronous transfer mode (ATM) processing circuit for processing ATM cells in said packet stream; and
a transport protocol/network protocol processing circuit for processing transport protocol/network protocol packets in said packet stream.

9. The apparatus of claim 1, further comprising:
rate padding circuitry for adjusting a rate of said digital stream data.

10. The apparatus of claim 1, further comprising:
system information/program specific information (SI/PSI) insertion circuitry for adding SI/PSI data to said digital stream data.

11. The apparatus of claim 1, further comprising:
program identifier (PID) processing circuitry for processing PIDs in said digital stream data.

12. The apparatus of claim 1, further comprising:
a program clock reference (PCR) circuit for processing time stamp data in said digital stream data.

13. The apparatus of claim 1, further comprising:
demodulation circuitry for demodulating command data from said at least one user terminal for transmission by said transceiver.

14. The apparatus of claim 1, wherein said local distribution facility comprises a coaxial cable medium.

15. The apparatus of claim 1, wherein said modulator employs one of quadrature amplitude modulation (QAM), vestigial sideband (VSB) modulation, quadrature phase-shift keying (QPSK) modulation, and coded orthogonal frequency division multiplexing (COFDM) modulation.

16. A content distribution system, comprising:
a headend for providing packetized data carrying digital stream data;
a transport system for propagating a signal configured to carry said packetized data;
a network interface, coupled to said transport system, comprising:
a transceiver for receiving a signal from said transport system and recovering said packetized data from said signal;
packet processing circuitry for extracting said digital stream data from said packetized data; and
a modulator for modulating said digital stream data onto at least one carrier;
a local distribution facility for receiving said at least one carrier; and
at least one user terminal, coupled to said local distribution facility, for processing said at least one carrier to display said digital stream data.

17. The system of claim 16, wherein said transport system comprises at least one of an optical facility, a copper facility, and a coaxial cable facility.

18. The apparatus of claim 16, wherein said signal is a digital subscriber line (DSL) signal.

19. A method for distributing digital stream data over a local distribution facility to at least one user terminal coupled thereto, the method comprising:
recovering a packet stream from a signal;
extracting digital stream data from said packet stream;
modulating said digital stream data onto at least one carrier; and
coupling each said at least one carrier to said local distribution facility.

20. The method of claim 19, further comprising:
up-converting said at least one carrier prior to coupling said at least one carrier to said local distribution facility.
